(19) United States
(12) Patent Application Publication
(10) Pub. No.: US 2011/0022655 A1
(43) Pub. Date: Jan. 27, 2011

(54) SMART-CARD BASED FAULT RESISTANT ON-LINE/OFF-LINE LOYALTY POINT ACCUMULATION SYSTEM FOR SPECTATOR EVENT VENUES

(75) Inventors: Richard Daniel Pinnick, London (GB); Gabriel Vago, London (GB); Timothy James Salmon, Hitchin Herfordshire (GB); Carmi David Gressel, Mobile Post Negev (IL)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: FORTRESSGB LTD., London (GB)

(21) Appl. No.: 12/922,766

(22) PCT Filed: Mar. 25, 2009
(86) PCT No.: PCT/IL09/00331

§ 371 Date: Sep. 15, 2010

Related U.S. Application Data
(63) Continuation of application No. 61/070,897, filed on Mar. 27, 2008.

(51) Int. Cl. G06F 15/16

(52) U.S. Cl. 709/203

(57) ABSTRACT

A computerized venue management system for managing a venue serving clients, the system comprising a multiplicity of portable computing devices each associated with a loyalty rating representing a client of the venue; a plurality of computerized delivery terminals each capable of communicating with and serving any one of the multiplicity of portable computing devices wherein at least a subset of the plurality of terminals is operative to enable delivery of at least one Loyalty based entitlement to at least one client of the venue and, in conjunction with delivery of the at least one entitlement, to enhance the individual portable computing device's loyalty rating, wherein the entitlement is computed to encourage more even distribution of clients over time by weighting at least one client's entitlement positively as a function of presence of the client's portable computing devices at the venue at times of lesser client attendance.

### REFERENCE TO CO-PENDING APPLICATIONS

Priority is claimed from U.S. Provisional Application No. 61/070,897, filed Mar. 27, 2008 and entitled “Fault Resistant On-Line/Off-Line Loyalty Benefit Scheme for Spectator Event Venues Based on Smart Cards and Accumulated Loyalty Points”.

### FIELD OF THE INVENTION

The present invention relates generally to venue management systems.

### BACKGROUND OF THE INVENTION

State of the art venue management systems are described in co-pending PCT Patent Applications WO2006/030410 and WO2007/086068, hereinafter “410” and “068”.

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide a fault resistant online/offline loyalty benefit scheme for sports and other spectator Venues based on normalized accumulated Member's Loyalty Points stored in Member's Smart Cards and in the Venue's computer; wherein the normalized Loyalty Points serve as a campaign manager's criteria for offering benefits to Members and wherein during the sport Venue's season, the criteria are issued to computerized points of contact prior to each Venue Event wherein the first point of contact subsequent to Member's gaining entrance to the Venue initializes the Member's card operative to allow transactions with campaign manager's criteria based Venue benefit terminals, wherein upon Member's receiving benefits, accumulated points are not reduced.

Certain embodiments of the present invention seek to provide computer controlled processes and systems for facilitating loyalty, purchases, coupons and information in an online and off-line mode within a venue e.g. stadium or other such public environment, utilizing one, some or all of server based card management systems, real time data capture, benefit rules and strategies and RFID contactless Smart Cards and devices.

Certain embodiments of the present invention seek to provide a fault resistant online/offline loyalty benefit scheme for sports and other spectator Venues based on normalized accumulated Member's Loyalty Points stored in Member's Smart Cards and in the Venue's computer; the normalized Loyalty Points which serve as a campaign manager's criteria for offering benefits to Members wherein during the sport Venue's season, the criteria are issued to computerized points of contact prior to each Venue Event wherein the first point of contact subsequent to Member's gaining entrance to the Venue initializes the Member's card which is operative to allow transactions with campaign manager's criteria based Venue benefit terminals, wherein upon Member's receiving benefits, accumulated points are not reduced.

Venues include Sports Arenas, Shopping Centres, Airports, University Campus and other mass-events environments. In the present specification, the term fan is interchangeable with supporter, visitor, member, traveller, shopper, client or other such description to represent the public user of an environment). Traditionally, such Venues have operated a multiplicity of systems governing every aspect of operations such as access (ticketing, access), payments (electronic point of sale “EPOS”), marketing (customer relationship management “CRM”) amongst others. Typically these systems are function specific and are not designed to interact with each other to form a connected eco-system.

In trying to deliver new services to fans the Venue may gather data from each of these functional systems and deliver real-time, just in time, tailored offerings that are typically beneficial for the fan. For example, a fan who is a frequent visitor is identified as entering the Venue; typically, via the access control system. The Venue may wish to reward the fan with an offer; e.g., a seat upgrade, a discount coupon, or a special invitation, which the fan can typically redeem then and there in real time through another of the functional systems, e.g., one of the POS (point of sale) systems in the Venue. In each case, the interactions with each system, needs to be governed, and the type and style of rewards needs to be governed.

Conventionally, this sort of interconnectivity has been achieved by physically integrating these diverse software systems directly with each other. Typically, a satisfactory integration can be achieved by either using a single (pre-integrated) software platform that provides the complete suite of functionality (if at all one exists), or by persuading the software system manufacturers to integrate their systems over an agreed upon interface. Both scenarios cause significant hardship and costs for the Venue operator and software vendors and as such are rarely pursued outside of the single merchant environment. This integration process is made even more complex when there exists a multiplicity of businesses operating within a single environment (such as in a shopping mall or an airport).

A particular feature of certain embodiments of the system for operation of a benefits and loyalty scheme shown and described herein is the integration of a multiplicity of modern apparatus and methods creating a real time communication and transaction platform which operates across a series of independent functional systems. In certain embodiments, the systems can operate in both an off-line and on-line mode, based around the interaction of a Smart Card or other portable device; e.g., a NFC (near field communication) mobile phone. Such a system would typically allow the holder to interact with various systems around the Venue and to receive and benefit from communications, rewards and incentives for his use of the Venue or loyalty to the Venue operator.

A particular feature of certain embodiments of the present invention is use of a Smart Card or smart device and a local benefits management system as the point of off-line or on-line interoperability between the Venues, Venue operators, and Venue systems.

Certain embodiments shown and described herein include a process for creating and negotiating loyalty and promotional interactions utilising a combination of server based card management systems, real time data capture, Event rule engines and RFID contactless Smart Cards. The process is designed to enable the card holder (the Member holding the RFID card) to interact with different applications in a real Venue environment (such as a Sports & Entertainment Venue, a shopping mall, a campus environment, or an airport) and where the output from one interaction may trigger the input to another interaction based on Event rules created within the Event Rule Engine. Such interactions may be physical in nature (such as enabling access via an access control application), or financial (such as enabling a payment transaction to occur), digital (such as a enabling the card holder to gain access to a digital environment or specific digital content i.e. computer login), promotional (such as enabling the card holder to benefit from a coupon or discount notice), visual (such as delivery of specific media content), or even human (such as the card holder being greeted by a designated person and promoting a human interaction).

A particular feature of certain embodiments of the present invention is that the interactions between the Smart Card and the Host applications are governed by a local rule engine (also termed herein a “Event Rule Engine”) that resides within the Interface Bridge that manages and sets-up determined patterns of managed executions e.g., “if a situation occurs of nature x then allow/do action y”. The trigger for each new Negotiation is either a Smart Card being placed on a reader attached to one of the applications wherein the Members identify themselves as being at a specific location or to be using a specific Host application. The input may be the binary data on the Smart Card itself or the data of a transaction happening at that time and the output may be a new data file written back to the Smart Card by the application. The content of this data file may be determined by the Event Rule Engine, whilst the production of the data file may be determined by the Card Management System. By placing the Event Rule Engine in localized Interface Bridges the system can determine the relevance and meaning of Member with Smart Card initiated triggers and locally generate Event offers simply by interpreting the binary data on the card and evaluating it against the relevant set of Event rules.

The outcome of such interactions may be a set of Event offers that are interpreted for the Host application to enable a transaction by Interface Bridge software. Hence, the local Host Application is not required to have direct communication with the Management Server and can work in an offline mode. This is particularly advantageous in a more distributed environment with a multiplicity of different Host Applications or where connectivity to a central server cannot be guaranteed. Placing a logic engine at the point of transaction enhances the fault resistance of the Negotiation process.

The following terms may be construed either in accordance with any definition thereof appearing in the prior art literature or in accordance with the specification, or as follows:
“Binary Data File”—typically an encrypted binary file created by the Central Application Server. This file may be encoded onto the Smart Card device. The data file contains within it such information that when presented to a local Interface Bridge, in turn enables the Host Application to verify and to proceed with an interaction.
“Benefit Offerings”—a generic term for a promotion, coupon, incentive or benefit entitlement offered by the Venue operator to Members of the Venue community. The type and terms of offer may be established by the Venue operator within the Campaign; may be dependent on at least one of: the location of the Member; the transaction history of the Member and the Venue management's strategy to increase paid attendance at Events which typically do not draw large crowds. Such offerings are typically granted to Members whose event specific Benefit Points exceed the event specific offering threshold.
“Campaign”—an integrated marketing program designed to tailor offerings to Members in a community typically commensurate with a multiplicity of system needs.
“Campaign Manager”—a server regulated application that typically enables the Venue and/or the Campaign Manager 16 to set-up a complete Campaign specifying the Benefit Strategy, the Benefit Offerings, the Negotiation triggers based on both the type and history of the interactions recorded by the Central Application Server, CAS.
“Cash Back Settlement Scheme”—Any system wherein a discount, benefit or rebate may be returned to the customer with a monetary value for future purchases typically in the same organization.
“Central Application Server (CAS)”—A server based application that manages the creation and modification of the binary data file that may be encoded on the Smart Card. The CAS may also communicate with the Host Applications to record each interaction between the Smart Card and that Host Application. The outcome of such interactions may be recorded in a database indexed to the Smart Card used.
“Event”—typically a sporting event in a given location Venue.
“Event Benefit Encoding”—encoding the Smart Card with the specific binary file that may be interpreted by an interface bridge and transacted by the host application for a forthcoming Event.
“Event Benefit Strategy”—rules stored within a Campaign Manager, which determine which Benefit Offers are delivered to a Member upon achieving the different levels of accumulated points.
“Event Rule Engine”—an operator that resides within an Interface Bridge that manages the flow configuration for a random sequence of Negotiation Triggers, each of which may have the form of: “if something happens of nature x then allow/do action y”.
“Host Applications”—software applications, such as EPOS (Electronic Point of Sale), access, payment systems, merchandising, retail software, that have been enabled to work with the Smart Card via the Interface Bridge by reading the binary data file on the Smart Card, reacting to the data and writing back new data to the Smart Card.
“Host Application Devices”—physical computer devices such as EPOS (electronic point of sale) terminals, Kiosks, Readers, etc. that run the Host Application software.
“Interface Bridge”—a family or a single software application that resides locally on the Host Application device and acts as an open query and response communication exchange between the data on the Smart Card, the Event rule engine and the various Host Applications. The Interface Bridge enables the Host Application to work with the Smart Card or Smart Device in an intelligent way in both an off-line and on-line mode, including reading and writing binary data to appropriate sectors on the Smart Card or Smart Device and enabling the transfer of data between the Host Application. It enables the Host Application to identify the “Negotiation Trigger” and determine Event offers that are appropriate for the Smart Card or smart device presented to the Interface Bridge.
“Interactions”—the flow of Negotiation Triggered “happenings” initiated by the cardholder using the Smart Card. Such interactions can typically be physical (i.e. opening of a door or turnstile), financial, and or informational.
“Interface Bridge”—A typically secured program for a Host Application to decode Event benefits.
“Kiosk Benefit Screen”—computer based kiosk which can be used by the Member to access information on his/her accumulated Loyalty Points and the presently proposed Event Benefit Offerings.
“Loyalty Points”—also called a Loyalty Score or Loyalty Rating, a weighted accumulation of benefit points, typically covering a history of attendance at Events, purchases of tickets to Events, or merchandise, etc. Typically, points are not spent when receiving benefits, and are principally a relative measure of the degree of benefits offered at a particular Event, commensurate to and based on the total number of points which could be accrued in a season of Events, at the time a Member enters a specific Event.
“Member”—a Smart Card—or smart device—owning user recognized by the system operator as belonging to an operator-authorised community. Also referred to as a fan, supporter, visitor, shopper, traveller, client or person.
“Negotiation Triggers”—specific Member/Smart Card initiated query sets that when achieved may result in the output or execution of an appropriate Event Offer entitlement.
“Normalising Factor”—factor by which an accrued number of points may be weighted for offering benefits at a specific Event; especially an Event which has known limited attraction; e.g., a Monday matinee.
“Online”—on-line communications are defined as those where there is typically no interruption of networked connections between computing terminals and the CAS.
“Offline”—off-line communications as those which are less dependent on uninterrupted network service; where, typically, pre and post-Event loading and unloading of transaction data may be executed either over the network, or alternately the data and application program may be transferred by personnel via memory devices from the CAS to the non-networked terminals, e.g. as described in patent documents “410” and “068”. Typically, on-line devices operate satisfactorily when network communications are disrupted.
“Upgrade”—a discretionary benefit option wherein the Venue management affords a Member the opportunity of attending a specific Event in a more desirable seating location.
“Season Accumulator”—accumulated number of Loyalty Points accrued by a Member through-out the season.
“Smart Card”—Typically passive RFID/Contactless Smart Cards operating at 13.256 MHz utilising Mifare, Legic, Inside or any other suitable open standard Smart Card chip technology; and/or at least one computer usable medium passive computer read/write memory store, e.g., magnetic stripe plastic cards, optical memory devices; and/or paper based smart devices wherein computer based reader writers can print and read single or two dimensional bar codes. In each case the Smart Card is typically encoded with a binary data file (“Binary Data file”). The Smart Card may come in a number of form factors including tags, wristbands, mobile phones, fobs and other portable devices. The terms Smart Card and Smart Device, portable computing devices, and computer usable medium are used herein generally interchangeably. Mifare AN10727 is manufactured by NXP, Gratchen; Inside Micropass 4000 Suite is manufactured by Inside Contactless, Aix en Provence; and Legic Prime SM05 Systems are manufactured by Legic, Wetzikon.
“Smart Card Reader”—designated reader for a Smart Card /Smart Device with read/write ability.
“Smart Device”—Near Field Communication Mobile Phone, a Smart Card or other portable device typically with a Smart Card emulating mode. Hereinafter, the terms Smart Device and Smart Card may be interchanged.
“Transaction history”—the total of interactions indexed to an individual active Member.
“Superior Seat”—a more desirable spectator location for attending, viewing or participating in an Event in a Venue. Typically, the admission price for a ticket to such a seating location is higher. Upgrades are typically granted from a less desirable seat to a superior seat.
“Venue”—A location for a significant event often mass-attended by a large group or audience, e.g. a music, sports or theatre event.

There is thus provided, in accordance with at least one embodiment of the present invention, a loyalty-based computerized system for uniformizing attendance distribution of clients over time, the system comprising a Campaign Manager; a multiplicity of portable computing devices e.g. smart cards or mobile phones; and a plurality of computerized terminals each capable of communicating with and serving any one of the multiplicity of portable computing devices located within a corresponding plurality of physical regions respectively, the regions together forming a closed area, wherein at least a subset of the plurality of terminals is enabled to manage delivery of at least one Loyalty Point based Event offering; each of the terminals having a decoding interface wherein reduced price, or other benefit offerings of services, product, seating upgrades are offered commensurate to the number of loyalty points credited to the Member, and to the Campaign Manager's decision of weighting the threshold of each Benefit Offering to the Venue Management's estimated probability and value of drawing an increased size crowd to a specific Event.

An encoded set of offerings may be loaded into a Member's Smart Card as the Member gains access to a Venue Event determined by a Campaign Manager device and distributed by a Central Application Server to each of the Negotiating Terminals Lucky Day offerings with a predefined probability of receiving a prize can be enacted wherein using a Random Number Generator and an encipherer, the Campaign Manager can randomly determine if a Member's Smart Card index identification number is a lucky number with a known probability. The Member's Loyalty Points are an Accumulation of credits relevant to paid for attendance at Events and for purchases of goods and services. The Venue's Directors can decide on a fraction of the accumulated Loyalty Points to be an Initial Value bonus for previous year's Members.

During the season of Events the Member accumulates Loyalty Points commensurate to points incremented for attendance at events and for purchase of goods and services in the Venue. Vital Member data may be encoded in the Member's Smart Card at the time of entrance in the Venue. Managed interactions may be physical in nature (such as enabling access via an access control application), or financial (such as enabling a payment transaction to occur), digital (such as a enabling the card holder to gain access to a digital environment or specific digital content i.e. computer login), promotional (such as enabling the card holder to benefit from a coupon or discount notice), visual (such as delivery of specific media content), or even human (such as the card holder being greeted by a designated person and promoting a human interaction).

At the start of an Event, all data in Smart Cards and Negotiating Computing Terminals may be reflected in the Central Application Server, so that in the event of disruption of network services Negotiation Terminals and Smart Cards can continue functioning with limited low risk without up-dating communications with the Central Application Terminal. The Central Application Server may be operative to broadcast marketing messages via SMS to Members whose Smart Device is a mobile telephone.

Also provided, in accordance with at least one embodiment of the present invention, is a system and method for creating Event Offers of multiple types based upon a Member's transaction history and triggered by the interaction of a Smart Card or Smart Device on a Host application via a Host Computer.

Further provided, in accordance with at least one embodiment of the present invention, is a system and method for using the Smart Card and Smart Card devices as the trigger for Event Offers in an on-line and off-line mode, wherein accumulated Loyalty Points are stored in the Smart Card, and the Venue Entering Access controller encodes the specific offerings based on the threshold values in the Event Benefit Ruler.

Also provided, in accordance with at least one embodiment of the present invention, is a Benefit Event Campaign Manager regulated offering ruler which, prior to an event, normalizes the number of accumulation points against the maximum estimated number of possible accumulated season loyalty points; the normalized points representing enablement of offerings commensurate to threshold values in the Campaign Manager's Benefit Ruler assembled for a particular Event.

Further provided, in accordance with at least one embodiment of the present invention, is a method of using mobile, email and other digital media for communicating Event Offers to Members.

Also provided, in accordance with at least one embodiment of the present invention, is a fault resistant online/offline loyalty benefit providing system for sports and other spectator Venues based on normalized accumulated Member's Loyalty Points stored in Member's Smart Cards and in the Venue's computer; the normalized Loyalty Points serving as a campaign manager's criteria for offering benefits to Members wherein during the sport Venue's season, the criteria are issued to computerized points of contact prior to each Venue Event wherein the first point of contact subsequent to Member's gaining entrance to the Venue initializes the Member's card operative to allow transactions with campaign manager's criteria based Venue benefit terminals, wherein upon Member's receiving benefits, accumulated points are not reduced.

Also provided is a computerized venue management system for managing a venue serving clients, the system comprising a plurality of computerized delivery terminals each capable of effecting transactions with clients in accordance with definitions of the transactions, wherein the definitions are computed to encourage more even distribution of clients over time by defining transactions to be more attractive to clients, at times of lesser client attendance and by defining transactions to be less attractive to clients, at times of greater client attendance.

Further provided, in accordance with at least one embodiment of the present invention, is a computerized venue management system for managing a venue serving clients, the system comprising a multiplicity of portable computing devices each associated with a loyalty rating accrued by a client of the venue; and a plurality of computerized delivery terminals each capable of communicating with and serving any one of the multiplicity of portable computing devices wherein at least a subset of the plurality of terminals is operative to enable delivery of at least one Loyalty based entitlement to at least one client of the venue and, in conjunction with delivery of the at least one entitlement, to enhance the individual portable computing device's loyalty rating, wherein the entitlement is computed to encourage more even distribution of clients over time by weighting at least one client's entitlement positively as a function of presence of the client's portable computing devices at the venue at times of lesser client attendance.

Further in accordance with at least one embodiment of the present invention, the system also comprises a central manager uploading to and downloading from the terminals between mass-attended events occurring at the venue.

Still further in accordance with at least one embodiment of the present invention, the central manager communicates with the terminals via a network.

Additionally in accordance with at least one embodiment of the present invention, each of the multiplicity of portable computing devices stores information allowing a loyalty based entitlement to which each individual computing device is eligible, to become known to a terminal interacting with the individual computing device, even when the network is not functioning.

Further in accordance with at least one embodiment of the present invention, the entitlements are defined for a period of time corresponding to an individual event held at the venue.

Also in accordance with at least one embodiment of the present invention, the entitlement is at least partly a function of a day of the week on which an entitlement is to be offered.

Further in accordance with at least one embodiment of the present invention, entitlements corresponding to an event expected to result in a low level of attendance are larger than entitlements corresponding to an event expected to result in a high level of attendance.

Additionally in accordance with at least one embodiment of the present invention, the central manager downloads to the terminals all client entitlements to be offered during at least one event and receives from the terminals, uploads of all deliveries of entitlements during the event, and computes at least one individual portable computing device's loyalty rating as a function of entitlement deliveries made to the individual computing device.

Further in accordance with at least one embodiment of the present invention, at least one of the terminals is operative to present a human-sensible output representing at least one of the loyalty based entitlements.

Still further in accordance with at least one embodiment of the present invention, at least one of the entitlements is client-specific rather than being identical for all clients and wherein at least one of the terminals is operative to present human-sensible output representing a client-specific entitlement specific to an individual client, upon being approached by an individual computing device associated with the individual client.

Further in accordance with at least one embodiment of the present invention, each of the plurality of computerized delivery terminals is capable of communicating with and serving any one of the multiplicity of portable computing devices located within a corresponding plurality of physical regions respectively, the regions together forming a restricted access area.

Additionally in accordance with at least one embodiment of the present invention, each terminal is operative to query a computing device for current status of entitlement, to effect delivery of the entitlement only if the current status of entitlement indicates current eligibility for the entitlement, and to change the computing device's current status of entitlement to reflect the delivery.

Still further in accordance with at least one embodiment of the present invention, at least a subset of the plurality of terminals includes a seating upgrade module operative to present information regarding vacant superior seats, to accept information indicating eligibility for a seating upgrade, and to allocate an individual vacant superior seat from among the vacant superior seats to a client eligible for a seating upgrade.

Also in accordance with at least one embodiment of the present invention, a client interaction system is provided comprising computerized recording apparatus for recording interactions with at least one client; at least one client loyalty score repository storing a loyalty score for at least one client for which at least one interaction has been recorded by the computerized recording apparatus; and a client loyalty computer operative to update the repository by only incrementing, and never decrementing, loyalty scores therewithin, at least during each of at least one loyalty score accumulation seasons.

Further in accordance with at least one embodiment of the present invention, the client loyalty computer increments loyalty scores for individual clients to reflect interactions with the individual clients as recorded in the computerized recording apparatus.

Also provided, in accordance with at least one embodiment of the present invention, is a computer program product, comprising a computer usable medium having a computer readable program code embodied therein, the computer readable program code adapted to be executed to implement a method for computerized management of a venue serving clients, the method comprising providing a multiplicity of portable computing devices each associated with a loyalty rating representing a client of the venue; and using a plurality of computerized delivery terminals to communicate with and to serve any one of the multiplicity of portable computing devices wherein at least a subset of the plurality of terminals is operative to enable delivery of at least one loyalty based entitlement to at least one client of the venue and, in conjunction with delivery of the at least one entitlement, to enhance the individual portable computing device's loyalty rating, wherein the entitlement is computed to encourage more even distribution of clients over time by weighting at least one client's entitlement positively as a function of presence of the client's portable computing devices at the venue event at times of lesser client attendance.

Also provided, in accordance with at least one embodiment of the present invention, is a computer program product, comprising a computer usable medium having a computer readable program code embodied therein, the computer readable program code adapted to be executed to implement a method for client interaction, the method comprising using computerized recording apparatus for recording interactions with a client; building a computerized client loyalty accumulator function storing a loyalty score for each client for which at least one interaction has been recorded by the computerized recording apparatus; and from the start of each venue event season, updating the accumulator function by only incrementing, and never decrementing, loyalty scores therewithin.

Further in accordance with at least one embodiment of the present invention, the venue comprises a restricted access area having entering venue points manned by computerized entry point managers operative to load the information allowing a loyalty based entitlement to which each individual computing device is eligible to become known, into each portable computing device passing through an entry point.

Still further in accordance with at least one embodiment of the present invention, the individual portable computing device's loyalty rating is incremented immediately on entry into the venue to reflect the loyalty shown by client's attendance at the venue event.

Also in accordance with at least one embodiment of the present invention, the computerized entry point managers are operative to increment the individual portable computing device's loyalty rating to reflect attendance at the venue event.

Further in accordance with at least one embodiment of the present invention, the information allowing a loyalty based entitlement for which each individual computing device is eligible comprises the loyalty based entitlement itself.

Also provided, in accordance with at least one embodiment of the present invention, is a computerized venue management method for managing a venue serving clients, the method comprising providing a multiplicity of portable computing devices each associated with a loyalty rating representing a client of the venue; and using a plurality of computerized delivery terminals to communicate with and to serve any one of the multiplicity of portable computing devices wherein at least a subset of the plurality of terminals is operative to enable delivery of at least one Loyalty based entitlement to at least one client of the venue and, in conjunction with delivery of the at least one entitlement, to enhance the individual portable computing device's loyalty rating, wherein the entitlement is computed to encourage more even distribution of clients over time by weighting at least one client's entitlement positively as a function of presence of the client's portable computing devices at the venue at times of lesser client attendance.

Also provided, in accordance with at least one embodiment of the present invention, is a client interaction method comprising using computerized recording apparatus for recording interactions with a client; building a computerized client accumulated loyalty score function storing a loyalty score for each client for which at least one interaction has been recorded by the computerized recording apparatus; and during an event season, updating the accumulated loyalty score function by only incrementing, and never decrementing, loyalty scores therewithin.

Also provide is a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display, store and accept information, including computer programs, in accordance with some or all of the teachings of the present invention, such as but not limited to a conventional personal computer processor, workstation or other programmable device or computer or electronic computing device, either general-purpose or specifically constructed, for processing; a display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and /or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1 is a top level pictorial illustration of interactive processes involved in granting benefits relative to Loyalty Points to Smart Card holding Members in an enclosed Venue.

FIG. 2 is a pictorial illustration of a process wherein the Venue and/or the Campaign Manager encodes a set of Benefit Offerings to Members of a closed Venue, commensurate to the normalized number of accumulated points factored to draw crowds to less attended Events.

FIG. 3 is a simplified flow chart of a method facilitating a Campaign Manager's encoding of values of accumulated Loyalty Points compliant with varied offerings so as to encourage Member attendance at less popular Events.

FIG. 4 is a simplified flow chart of a process of initializing and transacting with a Member's Smart Card including providing Benefit Offerings relevant to the Member's accumulated Loyalty Points so as to encourage attendance at less popular Events.

### DETAILED DESCRIPTION OF CERTAIN EMBODIMENTS

Attendance at venues tends to rise and fall periodically. For example, expected attendance tends to rise and fall on a weekly basis, with attendance rising over the weekend and falling again at the beginning of the week. Also, expected attendance may rise and fall on a seasonal basis, with attendance rising in season and falling again off-season. Different venues have different rising an falling patterns. It is desired to efficiently encourage clients to attend a venue at times of lesser congestion, by providing different computerized modes of venue management which can be actuated manually or automatically depending on the extent of congestion and which differ in their attractiveness to clients, thereby allowing attendance at certain times (such as low-congestion times) to be encouraged by simply selecting, at such times, a suitable computerized mode which makes attendance relatively attractive to clients, and by selecting, at other times (such as highly congested times), a suitable computerized mode which makes attendance less attractive to clients.

A computerized venue management system is provided for managing a venue serving clients, the system comprising a plurality of computerized delivery terminals each capable of effecting transactions with clients in accordance with definitions of the transactions, wherein the definitions are computed to encourage more even distribution of clients over time by defining transactions to be more attractive to clients, at times of lesser client attendance and by defining transactions to be less attractive to clients, at times of greater client attendance. For example, clients may gain more loyalty points if they attend and/or initiate transactions at times of lesser attendance and may gain less loyalty points if they attend and/or initiate transactions at times of greater attendance. It is appreciated that varying the number of loyalty points ceded to clients as a function of the congestion of the time at which the clients attend, is only one way of varying the attractiveness of transactions as a function of the congestion of the time at which the clients attend.

According to certain embodiments of the invention, pre-programmed modes of venue management are provided so as to allow the system to repeatedly and efficiently be transformed from a system serving a highly congested venue in which relatively less attractive transactions are offered, to a system serving an uncongested venue in which relatively more attractive transactions are offered. According to other embodiments of the invention, the modes can be programmed in by a human user of the system and typically are then stored to allow re-use. For example, a human manager of a stadium might program in a Monday-Night-mode, in which transactions are defined to be relatively attractive so as to encourage Monday night (off-night) attendance, and might activate this mode every Monday, and inactivate it every Tuesday.

Optionally, the system includes a user interface which displays to a human user a plurality of transactions to be defined, and enables the user to define these, such as but not limited to, by selecting one of several pre-defined options. For example, a user may be prompted to define, e.g. by selection, a number of loyalty points accrued by a user who attends an or who enters into a transaction in the course of the event, and/or may be prompted to define a value of a transaction entered into in the course of the event, either for all clients or separately for clients possessing different numbers of loyalty points.

Optionally, the system or a human user define one basic venue management mode including at least one numerical characteristics of at least one venue-client transaction, such as the number of loyalty points accrued when performing various transactions including, perhaps, the “transaction” of actually purchasing the right to attend the venue and attending de facto.

The human user is then prompted to define an event factor which may for example represent the expected congestion of a particular event occurring in the venue. The event factor is then used by the system to automatically generate an additional venue management mode by multiplying all numerical transaction characteristics defined in association with the basic mode, by the event factor.

Optionally, more than one event factor may be used simultaneously. For example, season factors may be defined for on-season and off-season, day-of-the-week factors may be defined for days of the week, and time-of-day factors may be defined for mid-day events as opposed to evening events. These event factors are then used by the system to automatically generate an additional venue management mode by multiplying all numerical transaction characteristics defined in association with the basic mode, by all relevant event factors. For example, the mode of management for a Friday mid-day off-season event might be generated by multiplying all characteristics of all transactions defined for the basic mode, by the product of the Friday day-of-the-week factor, the mid-day time-of-day factor, and the off-season season factor, e.g.:

Friday mid-day off-season event characteristic A for transaction I=(characteristic A for transaction I as per basic mode)×(Friday factor×mid-day factor×off-season factor).

According to this embodiment, venue management may include the following steps:
a. system or user define one basic venue management mode including at least one numerical characteristics of at least one venue-client transaction, such as the number of loyalty points accrued when performing various transactions
b. user defines a plurality of event factors which may correspond to a plurality of levels of expected congestion
c. system computes a plurality of additional venue management modes by multiplying each numerical characteristic of each transaction defined in step (a), by the event factor
d. human venue manager sets up separately for each event, for selecting one of the available venue management modes or by selecting a plurality of modes to be multiplied by one another
e. during each event, the venue is managed by having all transactions occur in accordance with the numerical characteristics defined within the mode selected by the human venue manager in step d.

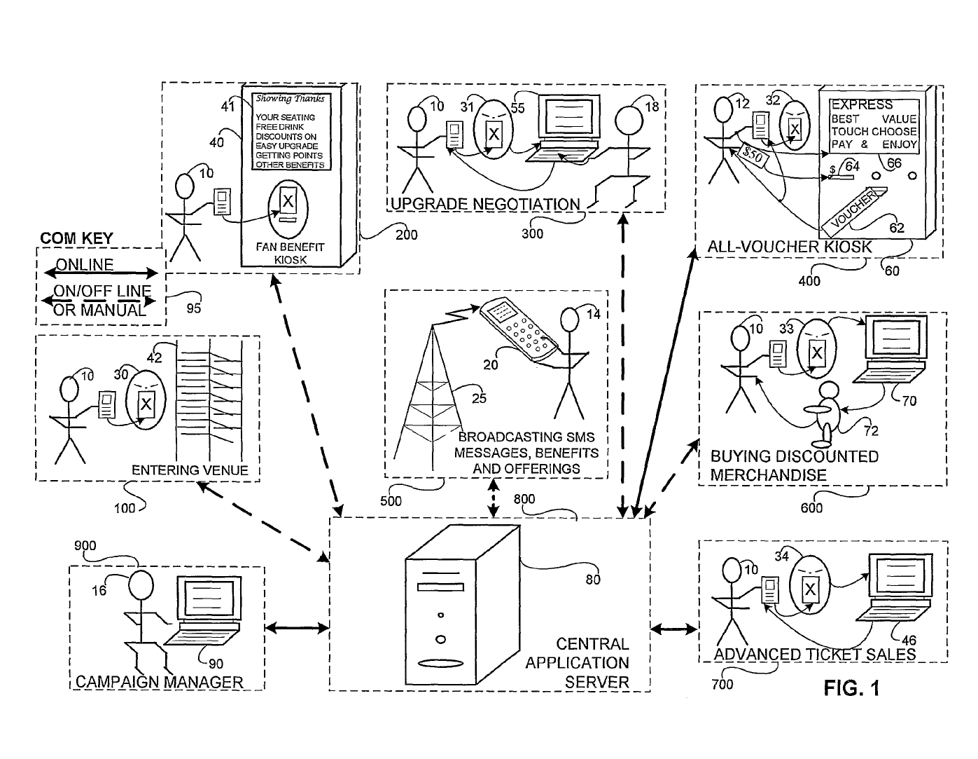

FIG. 1 is a pictorial illustration of a computerized interactive system operative typically operative both in off-line and on-line to distribute measured benefits to Members at a Venue Event. Such rewards are designed to benefit both the Venue and participating Members at the Venue.

Typically, the only vital communication link, prior to and following an event between depicted Negotiating computing terminals 30, 40, 46, 55, 60, and 70 and the central application server 80, is operative to initialize the terminals with the benefit function rules and updated knowledge of Members' accumulated Loyalty Points, and in some instances their financial status as related to the Venue. Vital Member data is encoded in the Member's Smart Card and is reflected in the Central Application Server 80 memory. The Member data is typically updated at the first instant when a Member enters the Venue. The preferred mode of operation is on-line; in the event of network failure, vital Member information may be kept in the Smart Card, and necessary transaction information may be held in the negotiating process computer and all of which is typically sufficient to enable a low risk transaction.

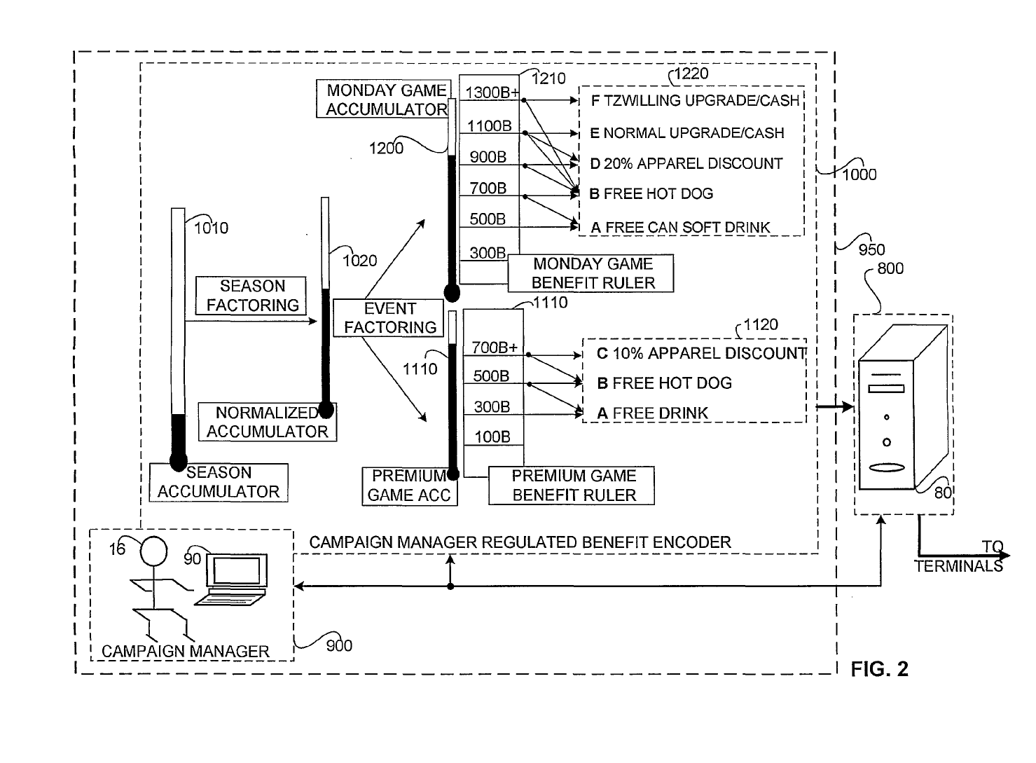

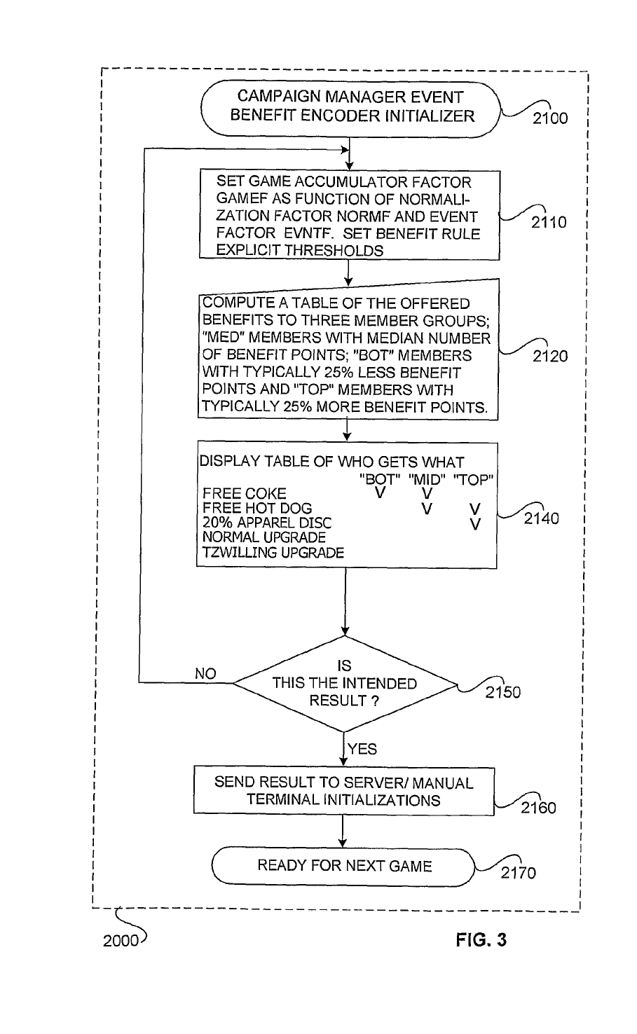

In line with the Venue strategy of granting benefits, in Event Benefit Encoding process 900, in FIGS. 1 and 2, the Campaign Manager 16 typically encodes and ascertains a unique model of efficacy of Strategy Rules depicted in FIGS. 2 and 3. The benefit Strategy Rules, graphically depicted in FIG. 2, are transmitted via the Central Application Server 80 to computing terminals 30, 40, 46, 55, 60 and 70 using technology described in the above-referenced patent documents “410” and “068” in processes 100, 200, 300, 400, 500, 600, 700 and 800.

Solid arrows shown in Com Key 95 signify processes that are fully operative when on-line, but which can be operated with limited risk off-line. The broken line double headed arrows signify lines of communication which are less affected by disruption of network service during an event; e.g., transaction reports may be delayed. All Smart Card negotiations, with the exception of advance obligations which demand central server 80 approval, are typically fault resistant and low risk operative during an Event.

In the Entering Venue process 100, the above described negotiating computing devices have previously been initialized for an Event; subsequently, a Member with a Smart Card 10 may be allowed to present her/himself to Smart Card reader 30. At such an instant, the Member with Smart Card 10 is typically identified to the Venue system. Typically, Smart Card reader 30 activates gated turnstile 42, thereby allowing Member with Smart Card 10 access to the Venue. Typically, Smart Card reader 30 simultaneously initializes Member's Smart Card with encoded Benefit Offerings as prescribed by the Event Benefit Strategy. In certain embodiments, prior to onset of an event, Central Application Server 80 downloads all relevant Membership status data, typically including each Member's accumulated Loyalty points to a Smart Card reader 30 controlling computer's memory. In cases of non-compliance between data stored in reader 30 in on-line mode of operation and Member's Smart Card 10 data, reader 30 typically queries Central Application Server 80.

Member 10 with Smart Card or Member 14 with compliant mobile phone 20, in process 200 or 500 respectively, learns of her/his specific Benefit Offerings on Kiosk Benefit Screen 41, on printed read out from terminal 40 or on Member 14's mobile phone screen.

In process 300, the seating upgrade module, Member 10 with Smart Card may be identified by terminal 55 with an Upgrade Benefit Upgrade Negotiator 18 wherein Member 10 and Negotiator, 18, typically, are operative to reach a deal for upgrading compliant with the Benefit Offering and/or a Cash Back, should the Member be unable to utilize the Benefit Upgrade.

Process 400 includes a hybrid cash/benefit transaction, wherein Member 12, with entitling Smart Card and cash, selects e.g. via touch-screen 66 a product or service voucher 62 and simultaneously tops up his electronic purse by depositing cash in acceptor 64. Typically, such transactions are authorized on line by Central Application Server 80, in EPOS charge process 800.

In process 600 Member with Smart Card 10 places Smart Card on Smart Card reader 33 and selects discounted merchandise on terminal 70. Merchandise 72 may be delivered, and Smart Card reader 33 deducts the final purchase price from Member 10's Smart Card. In another preferred embodiment, the reader 33 may deduct the full price from the Member's Smart Card, and may issue a voucher or credit a purse in the Member's Smart Card.

Advanced ticket sales are managed in process 700 as Smart Card reader 34 reads identification and state of electronic purse data to terminal 46; wherein Member 10 selects seating arrangement in terminal 46. Process 800 in Central Application Server 80 manages ticket sale, charges Member 10 for the advanced ticket, and records relevant data in the forthcoming Event.

FIG. 2 is a pictorial illustration of evolution of a set of Benefit Strategy Rules to be enacted on Smart Cards entering the Venue. During a season, a Member accrues Loyalty Points for purchased tickets, services and product, wherein the Member's accumulation is depicted by the height of the “mercury” in Season Accumulator 1010. The “mercury” may be an imaginary construct merely for purposes of illustration, or may be actually displayed to a user using a suitable computer graphics display medium. Typically, a Campaign Manager will assume approximately what portion of “estimated total season points” an average Member has accrued, ESTPA; e.g. ESTPA=0.13, 13% of season points have been accumulated. A typical Normalizing Factor, NORMF, is the inverse of ESTPA, NORMF=1/ESTPA; e.g., 1/0.13=7.7, and a Member with 37 points would be entitled to 37×7.7=285 Normalized Accumulated Points in Normalized Accumulator 1020.

The Event Benefit Strategy typically includes an Event Factor, EVNTF, to establish a larger benefit for attendance at less popular Events; e.g., typically the largest EVNTF is granted to a Monday afternoon game wherein one team is low on the league table, and, typically, the lowest EVNTF is granted for a weekend game between top level teams. In preferred embodiments, EVNTF typically varies according to classes of membership. The final Game Factor, GAMEF, typically equals the final NORMF times EVNTF.

Example: Assume in FIG. 2 that NORMF=7.7; assume an EVNTF for a Monday Night Game would be 3.1; therefor for the Member with 37 points; the Member's Event Accumulator, EVACC included value is:

7.7×3.1×37=883B Benefit points.

Typically, the next task is to re-establish the threshold of EVACC Benefit points necessary to grant a specific Benefit, and when necessary, the exact amount of a particular Benefit which is to be granted; e.g., a Tzwilling (double upgrade), may typically grant either a single upgrade for the winning Member and a second Member, a double upgrade for the winning Member, or two upgrades for the winning or the second Member. In the event that the Member cannot benefit from the Upgrade, or chooses not to receive the Upgrade, a “Cash Back” credit can be generated for purchases of Venue product, services and/or Event tickets. According to threshold and benefit as indicated at reference numerals 1210 and 1220, a Tzwilling Upgrade includes in addition, a benefit such as “Free Hot Dog”. Similarly, a Normal Upgrade may alternately receive a Cash Back, in addition to a 20% Apparel Discount.

Typically, the Campaign Manager generates a Display Table 2140 in FIG. 3, using estimated EVACC points for several classes of Members. If the table meets expectations, the Campaign Manager transmits the rule set to the Central Application Server to be forwarded to all participating Venue terminals.

Typically, Benefit Offerings are indexed alphabetically, where each relevant offering is defined for compliant terminals; e.g., offering Index C, in Smart Card Holder 10 specifies to terminal 70 to grant Smart Card Holder a product, such as apparel, at a 20% discount, and offering Index B would grant the Card Holder a free food item at a food counter, not depicted in FIG. 1

Typically, the Campaign Manager specifies a random function that will unpredictably execute a one-time addition of Accumulated Points to a “lucky” Member, when entering the Venue in FIG. 1. Process 100 may for example choose a lucky number probability of the lucky number, as 1/n; where n is an odd number. Next, a new true random number secret key may be used to encrypt the card index number to Y where the maximum possible output value may be at least an order of magnitude larger than n, the inverse of the probability. For example: A choice of the winning number can be y mod n′, wherein y can be any typically positive random number less than n′−1 and where n′ is equal to n±13 (plus 13 for even numbered days of month, and minus 13 for odd days of the month). The prize winning Member will typically collect a benefit Voucher at a Kiosk 400.

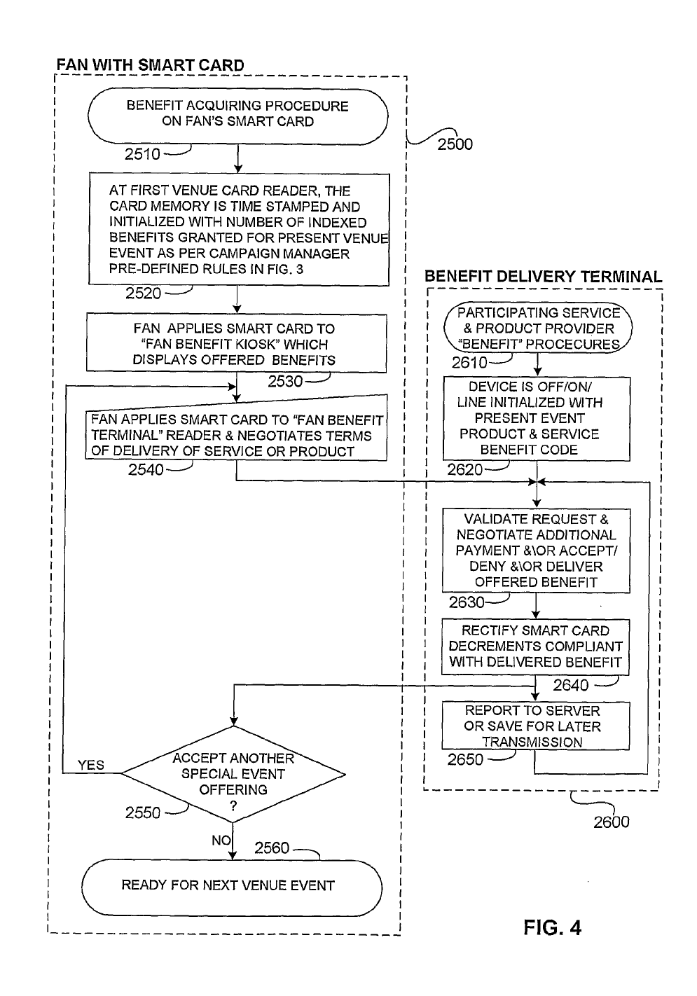

FIG. 3 is a simplified self-explanatory flow chart typifying action elements also described in FIG. 2. The method of FIG. 3 typically comprises some or all of the illustrated steps, suitably ordered e.g. as illustrated. FIG. 4 is a simplified self-explanatory flow chart illustration of an method for facilitating an interaction between a Member and a multiplicity of Benefit Terminals following procedures 100 to 600. The method of FIG. 4 typically comprises some or all of the illustrated steps, suitably ordered e.g. as illustrated.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, Home PNA, power line communication, cell phone, PDA, Blackberry GPRS, Satellite including GPS, or other mobile delivery.

1. A computerized venue management system for managing a venue serving clients, the system comprising:
a multiplicity of portable computing devices each associated with a loyalty rating accrued by a client of a venue; and
a plurality of computerized delivery terminals each capable of communicating with and serving any one of the multiplicity of portable computing devices wherein at least a subset of the plurality of terminals is operative to enable delivery of at least one Loyalty based entitlement to at least one client of a venue and, in conjunction with delivery of the at least one entitlement, to enhance the individual portable computing device's loyalty rating, wherein the entitlement is computed to encourage more even distribution of clients over time by weighting at least one client's entitlement positively as a function of presence of the client's portable computing devices at a venue at times of lesser client attendance.

2. A system according to claim 1 and also comprising a central manager uploading to and downloading from said terminals between mass-attended events occurring at a venue.

3. A system according to claim 2 wherein said central manager communicates with said terminals via a network.

4. A system according to claim 3 wherein each of the multiplicity of portable computing devices stores information allowing a loyalty based entitlement to which each individual computing device is eligible, to become known to a terminal interacting with said individual computing device, even when the network is not functioning.

5. A system according to claim 1 wherein said entitlements are defined for a period of time corresponding to an individual event held at a venue.

6. A system according to claim 1 wherein said entitlement is at least partly a function of a day of the week on which an entitlement is to be offered.

7. A system according to claim 5 wherein entitlements corresponding to an event expected to result in a low level of attendance are larger than entitlements corresponding to an event expected to result in a high level of attendance.

8. A system according to claim 2 wherein said central manager downloads to the terminals all client entitlements to be offered during at least one event and receives from said terminals, uploads of all deliveries of entitlements during said event, and computes at least one individual portable computing device's loyalty rating as a function of entitlement deliveries made to said individual computing device.

9. A system according to claim 1 wherein at least one of said terminals is operative to present a human-sensible output representing at least one of said loyalty based entitlements.

10. A system according to claim 9 wherein at least one of said entitlements is client-specific rather than being identical for all clients and wherein at least one of said terminals is operative to present human-sensible output representing a client-specific entitlement specific to an individual client, upon being approached by an individual computing device associated with said individual client.

11. A system according to claim 1 wherein each of the plurality of computerized delivery terminals is capable of communicating with and serving any one of said multiplicity of portable computing devices located within a corresponding plurality of physical regions respectively, said regions together forming a restricted access area.

12. A system according to claim 4 wherein each terminal is operative to query a computing device for current status of entitlement, to effect delivery of said entitlement only if the current status of entitlement indicates current eligibility for the entitlement, and to change the computing device's current status of entitlement to reflect said delivery.

13. A system according to claim 1 wherein at least a subset of said plurality of terminals includes a seating upgrade module operative to present information regarding vacant superior seats, to accept information indicating eligibility for a seating upgrade, and to allocate an individual vacant superior seat from among said vacant superior seats to a client eligible for a seating upgrade.

14. A client interaction system comprising:
computerized recording apparatus for recording interactions with at least one client;
at least one client loyalty score repository storing a loyalty score for at least one client for which at least one interaction has been recorded by said computerized recording apparatus; and
a client loyalty computer operative to update said repository by only incrementing, and never decrementing, loyalty scores therewithin, at least during each of at least one loyalty score accumulation seasons.

15. A system according to claim 14 wherein said client loyalty computer increments loyalty scores for individual clients to reflect interactions with said individual clients as recorded in said computerized recording apparatus.

16. A computer program product, comprising a computer usable medium having a computer readable program code embodied therein, said computer readable program code adapted to be executed to implement a method for computerized management of a venue serving clients, the method comprising:
providing a multiplicity of portable computing devices each associated with a loyalty rating representing a client of a venue; and
using a plurality of computerized delivery terminals to communicate with and to serve any one of said multiplicity of portable computing devices wherein at least a subset of said plurality of terminals is operative to enable delivery of at least one loyalty based entitlement to at least one client of a venue and, in conjunction with delivery of said at least one entitlement, to enhance the individual portable computing device's loyalty rating, wherein said entitlement is computed to encourage more even distribution of clients over time by weighting at least one client's entitlement positively as a function of presence of said client's portable computing devices at a venue event at times of lesser client attendance.

17. A computer program product, comprising a computer usable medium having a computer readable program code embodied therein, said computer readable program code adapted to be executed to implement a method for client interaction, the method comprising:
using computerized recording apparatus for recording interactions with a client;
building a computerized client loyalty accumulator function storing a loyalty score for each client for which at least one interaction has been recorded by said computerized recording apparatus; and
from the start of each venue event season, updating said accumulator function by only incrementing, and never decrementing, loyalty scores therewithin.

18. A system according to claim 4 wherein said venue comprises a restricted access area having entering venue points manned by computerized entry point managers operative to load the information allowing a loyalty based entitlement to which each individual computing device is eligible to become known, into each portable computing device passing through an entry point.

19. A system according to claim 18 wherein the individual portable computing device's loyalty rating is incremented immediately on entry into a venue to reflect the loyalty shown by client's attendance at a venue event.

20. A system according to claim 19 wherein said computerized entry point managers are operative to increment the individual portable computing device's loyalty rating to reflect attendance at a venue event.

21. A system according to claim 4 wherein said information allowing a loyalty based entitlement for which each individual computing device is eligible comprises said loyalty based entitlement itself.

22. A computerized venue management method for managing a venue serving clients, the method comprising:
providing a multiplicity of portable computing devices each associated with a loyalty rating representing a client of a venue; and
using a plurality of computerized delivery terminals to communicate with and to serve any one of said multiplicity of portable computing devices wherein at least a subset of said plurality of terminals is operative to enable delivery of at least one Loyalty based entitlement to at least one client of a venue and, in conjunction with delivery of said at least one entitlement, to enhance the individual portable computing device's loyalty rating, wherein said entitlement is computed to encourage more even distribution of clients over time by weighting at least one client's entitlement positively as a function of presence of said client's portable computing devices at a venue at times of lesser client attendance.

23. A client interaction method comprising:
using computerized recording apparatus for recording interactions with a client;
building a computerized client accumulated loyalty score function storing a loyalty score for each client for which at least one interaction has been recorded by said computerized recording apparatus; and
during an event season, updating said accumulated loyalty score function by only incrementing, and never decrementing, loyalty scores therewithin.
